(19) United States
(12) Patent Application Publication
(10) Pub. No.: US 2026/0218531 A1
(43) Pub. Date: Jul. 30, 2026

(54) MASS DAMPER ASSEMBLY, IN PARTICULAR FOR TALL, SLIM BUILDINGS, AND METHOD FOR INSTALLING A MASS DAMPER ASSEMBLY

(71) Applicant: WÖLFEL ENGINEERING GMBH + CO. KG, Höchberg (DE)

(72) Inventors: -Ing. Jürgen ENGELHARDT, Eisingen (DE); -Ing. Sebastian KATZ, Würzburg (DE); M. Sc. David ZELTNER, Würzburg (DE)

(73) Assignee: WÖLFEL ENGINEERING GMBH + CO. KG, Höchberg (DE)

(21) Appl. No.: 19/147,654

(22) PCT Filed: Jan. 12, 2024
(86) PCT No.: PCT/EP2024/050677

§ 371 Date: Jul. 11, 2025

(30) Foreign Application Priority Data
Jan. 17, 2023 (EP) 23151865.5

(51) Int. Cl. E04H 9/02

(52) U.S. Cl. CPC E04H 9/0215

(57) ABSTRACT

The invention relates to a vibration damper arrangement and a method for installing a vibration damper arrangement (1), in particular for tall, slender buildings. The vibration damper assembly (1) comprises a supporting structure (2), a damper mass (4), at least one wheel (6, 7) by means of which the damping mass (4) is movable, on a concave rail assembly (8) connected to the supporting structure (2), from a stable central position in two opposite movement directions, and a stop assembly comprising, for each of the movement directions of the damper mass on the rail arrangement, a stop buffer on the damper mass, and a stop against which the stop buffer comes to abut. According to the invention, for the purpose of simple assembly, a distance between the stop buffer (14, 15) and the stop (11, 12) in the stable central position of the damper mass (4) is variable for at least one of the movement directions, and the stop arrangement varies, in the case of varying the distance in the one of the movement directions, the distance in the opposite movement direction equally in an opposite manner.

The present invention relates to a vibration damper arrangement, especially for tall, slender buildings, with a supporting structure, an damper mass having a center of mass, at least one wheel by means of which the damper mass is movable, on a concavely curved rail arrangement connected to the supporting structure, from a stable central position in two opposite movement directions, and a stop arrangement comprising, for each of the movement directions of the damper mass on the rail arrangement, a stop buffer on the damper mass and a stop against which the stop buffer comes to rest.

Furthermore, the invention relates to a method for setting up a vibration damper arrangement, especially for tall, slender structures, with a supporting structure, a damper mass having a center of mass, at least one wheel by means of which the damper mass can be moved, on a concavely curved rail arrangement connected to the supporting structure, from a stable central position in two opposite movement directions, and a stop arrangement comprising, for each of the movement directions of the damper mass on the rail arrangement, a stop buffer on the damper mass and a stop against which the stop buffer comes to rest.

Such a vibration damper arrangement is known, for example, from EP 2 746 483 B1.

From JP H11-94 017 A, a vibration dampening device is known that can be attached to a building. A weight is accommodated in an elongate housing and is displaceable along a curved path.

JP 2000-002 017 A describes an earthquake dampening device with a weight movable on a rail. The impact of the weight on a collision block is braked by a collision plate which is connected via springs and dampers. One position of the collision plate is adjustable.

The invention is described in the following with reference to its use in the tower of a wind turbine. However, it can also be applied to other tall and slender structures, e.g. chimneys, antennas, high-rise buildings, towers or offshore buildings such as transformer stations. A “tall and slender building” should be understood as a building that has a ratio between height and minimum width of at least 5.

The tower of a wind turbine is excited to perform vibrations, for example by wind forces or—in the case of offshore turbines—also by wave forces. The tower vibrates at a relatively low frequency of less than 1 Hz. Typically, the tower of an offshore wind turbine has a natural frequency in the range of 0.1 to 0.3 Hz. With every vibrational movement, the tower bends slightly, which can lead to problems in the long term.

It is therefore known to use a vibration damper whose damper mass can be moved back and forth on a curved rail arrangement. A line that runs through the center of a wheel and the point of abutment of the wheel on the rail arrangement intersects with a corresponding line of the wheel at another position. The crossing point then forms, so to speak, the suspension for a pendulum such that a distance between this crossing point and the center of mass, in other words the pendulum length, can be made very large.

The low frequency at which the wind turbine oscillates requires small damper frequencies and stiffnesses and thus large damper travels, which are, however, limited by installation space constraints. The damper mass must be able to move within the tower of the wind turbine. The movement of the damper mass must therefore be limited within a certain available path, which is restricted to the interior of the tower.

The tower of a wind turbine should be vertical. However, an exact alignment of the tower in a direction of gravity is achieved only in exceptional cases. However, the resulting inclination of the tower is acceptable for structural reasons because it is very slight and is well below five degrees.

However, slight inclinations of the system mean that the damper mass, when it is in its stable central position, is no longer arranged in the middle of the rail arrangement.

It has therefore been proposed to equip the vibration damper arrangement with a leveling device that makes it possible to align the vibration damper arrangement exactly horizontally after installation in the supporting structure. However, this requires a relatively high level of effort. The leveling device must not have any negative effects on the vibration damping. The vibration damper arrangement equipped with a leveling device must also be able to absorb the forces occurring during the movement of the damper mass and the associated reaction forces.

The invention is based on the object simplifying the assembly of the vibration damper arrangement.

This object is solved by a vibration damper arrangement, especially for tall, slender structures, with a supporting structure, a damper mass which has a center of mass, at least one wheel by means of which the damper mass is movable, on a concavely curved rail arrangement connected to the supporting structure, from a stable central position in two opposite movement directions, and a stop arrangement comprising, for each of the movement directions of the damper mass on the rail arrangement, a stop buffer on the damper mass and a stop against which the stop buffer comes to rest, wherein a distance between the stop buffer and the stop in the stable central position of the damper mass is variable (changeable) for at least one of the movement directions.

The vibration damper arrangement can then be mounted in the supporting structure without the need of operating a leveling device in order to align the vibration damper arrangement horizontally. If the supporting structure is inclined or tilted, the damper mass is in its rest position, which forms a stable center position, is no longer in the middle of the rail arrangement such that different distances are available in the two movement directions in which the damper mass can move. By adjusting the distance between the stop buffer and the stop in this position of the damper mass on at least one side, the two distances can now be aligned again such that the damper mass can move on the rail arrangement in an equal manner in both movement directions. Adjusting the distance is much easier than aligning the vibration damper arrangement horizontally.

In a preferred embodiment, the stop arrangement automatically varies (changes), in the case of varying (changing) the distance in the one of the movement directions, the distance in the opposite movement direction equally in an opposite manner. This means that if the distance on one side is increased, the distance on the other side is reduced to the same extent and vice versa. This simplifies the assembly further.

Preferably, at least one stop buffer is arranged adjustably on the damper mass. Adjusting the stop buffer on the damper mass is a relatively simple approach of varying the distance between the stop buffer and the stop.

Herein, it is preferable that the two stop buffers are arranged on the damper mass so as to be jointly adjustable for both of the movement directions. This means that only a single measure is required to adjust both distances, namely to vary the position of the two stop buffers on the damper mass. The two stop buffers can have a common housing for this purpose, for example.

Preferably, the respective stops transfer impact forces from the respective stop buffers to the supporting structure. This can be achieved by attaching the stops to the housing of the vibration damper arrangement, which in turn is rigidly connected to the supporting structure. The vibration damper arrangement can be constructed in a relatively simple mechanical manner.

Herein, it is preferable that the stops are rigidly attached to the supporting structure. The impact forces are thus transferred directly to the supporting structure.

Preferably, the stop buffers have a common damping element. The damping element ensures that the forces generated when the damper mass collides with the stop can be kept small. If one can use a common damping element for both stop buffers, the available installation space can be used particularly well. Especially, compared to a situation in which each stop buffer requires its own damping element, the damping element can be made practically twice as large. The damping element may, for example, comprise a spring or a hydraulic damper or a spring-damper unit.

Herein, it is preferred that the damping element defines a braking distance that corresponds to at least 10% of a maximum deflection of the damper mass. The movement of the damper mass is not stopped abruptly at the end of the movement, but the damper mass is decelerated over a relatively long braking distance such that loads on the supporting structure can be kept small.

Preferably, a line connecting the two stop buffers runs in a region that extends on both sides of the center of gravity of the damper mass in the direction of gravity and has an extension in the direction of gravity of 15% of the height of the damper mass at the maximum. This makes it possible to keep the forces that arise when the damper mass collides with the supporting structure small, wherein the impact damper and the stop are of course interposed, and to prevent a large tilting moment on the damper mass.

Preferably, the line runs in the direction of gravity below the center of gravity of the mass. As the movement of the damper mass due to the pendulum motion is not only a linear movement, but also has a rotational component, it is advantageous to mount the stop buffer vertically offset so that a torque counteracting the rotational movement is generated when the stop buffer collides with the stop. The stop buffer is therefore located close to, but slightly below the center of gravity of the damper mass in the direction of gravity.

The object mentioned above is further solved by a method for setting up a vibration damper arrangement, especially for tall, slender structures, with a supporting structure, a damper mass which has a center of mass, with at least one wheel by means of which the damper mass is movable, on a concavely curved rail arrangement connected to the supporting structure, from a stable central position in two opposite movement directions, and a stop arrangement comprising, for each of the movement directions of the damper mass on the rail arrangement, a stop buffer on the damper mass and a stop against which the stop buffer comes to rest, wherein a distance between the stop buffer and the stop in the stable central position of the damper mass is varied for at least one direction of movement.

One can allow then that the vibration damper arrangement is no longer aligned exactly horizontally and that the damper mass is no longer exactly in the center of the rail arrangement. Nevertheless, by varying the distance between the stop buffer and the stop, it is possible to ensure that the movement possibilities of the damper mass can be made the same in both directions of vibration.

Herein, it is preferable that when the distance in the one of the movement directions is varied, the distance in the opposite movement direction is automatically varied in the same equally in an opposite manner. This change can be made automatically, i.e. without having to take any further action. If the distance in one direction of movement is reduced, the distance on the other side of the direction of movement is increased accordingly, so that the distances can easily be made equal.

Herein, it is preferred to vary the position of the stop buffers on the damper mass. This is a relatively simple measure for adapting the distances to each other.

Preferably, the damper mass is arranged in the stable central position and the stop buffers are arranged on the damper mass such that the distance between the stop buffers and the respective stops is the same in each case. The damper mass automatically gets into the stable center position. If the damper mass is always in motion due to a vibration of the supporting structure, the distance traveled between two extreme positions can be determined and the damper mass can then be fixed in the middle of this distance. The distance between the stop buffer and the stop on one or both sides can then be easily changed.

According to one aspect, a common damping element can be used for the stop buffers.

The invention is described below by means of a preferred embodiment example in combination with the drawings. Herein show:

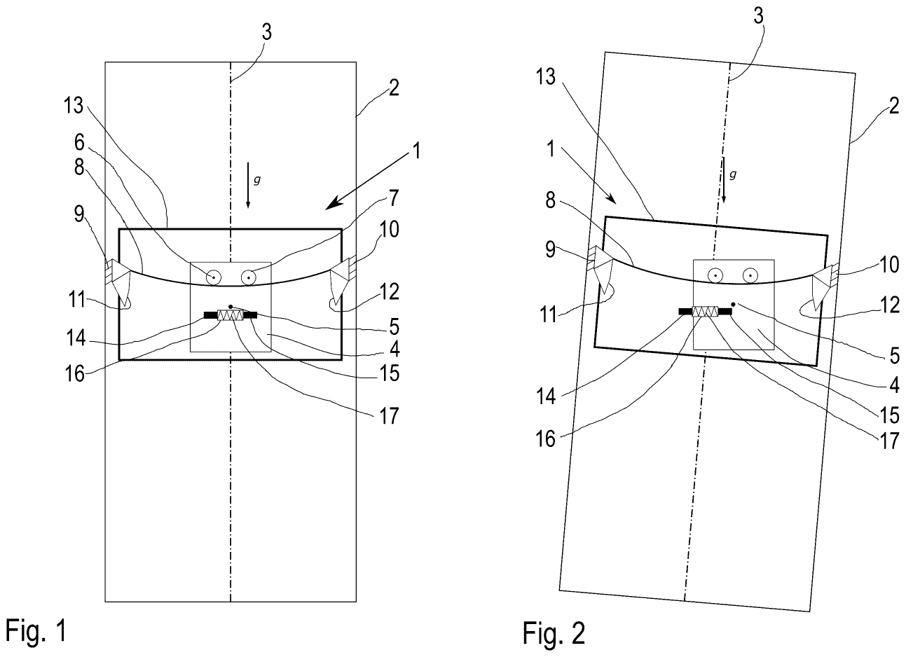

FIG. 1 a schematic view of a vibration damper arrangement in a structure aligned in the direction of gravity, and

FIG. 2 the vibration damper arrangement in a structure that is inclined to the direction of gravity.

FIG. 1 shows a vibration damper arrangement 1 in a supporting structure 2. The supporting structure 2 is a tall, slender building, for example the tower of a wind turbine. In all figures, the same elements are marked with the same reference signs.

In the situation shown in FIG. 1, the supporting structure 2 is aligned parallel to a direction of gravity g, i.e. a central axis 3 of the supporting structure 2 runs parallel to the direction of gravity.

The vibration damper arrangement 1 comprises a damper mass 4 with a center of mass 5. The damper mass 4 is movable by means of wheels 6, 7 on a concave rail 8 from a stable central position in two opposite directions. The stable center position is a position in which the damper mass 4 can no longer move further downwards in the direction of gravity. The damper mass 4 can have a mass of several tons. For example, it can be made of concrete, of steel, of a combination of steel and concrete, or of other materials.

The damper mass 4 and the rail arrangement 8 are arranged in a housing 13 of the damper arrangement 1.

However, the rail arrangement is connected directly to the supporting structure 2 via connecting elements 9, 10. This makes it possible to minimize the forces acting on the housing 13. It is also possible to fasten the housing 13 directly in the supporting structure with sufficient rigidity, i.e. without elastic compliance, so that the housing 13 simultaneously forms the connecting elements 9, 10.

One connecting element 9 has a stop 11 and the other connecting element 10 has a stop 12 for the movement of the damper mass 4. If the housing 13 is fastened sufficiently rigidly in the supporting structure 2, the housing 13 can also form the stops 11, 12.

The damper mass 4 has a first stop buffer 14, which can come into contact with the first stop 11 when the damper mass 4 has moved far enough in this direction. The damper mass 4 also has a second stop buffer 15, which comes into contact with the second stop 12 when the damper mass 4 has moved far enough in the opposite direction, i.e. towards the connecting element 10.

The two stop buffers 14, 15 have a common housing 16, which is attached to the damper mass 4. Furthermore, the two stop buffers 14, 15 have a common impact damper 17. The impact damper 17 causes the speed of the damper mass 4 to decrease more at the end of its movement than it would be the case due to the curved rail arrangement 8 alone. This prevents the damper mass 4 from hitting the supporting structure 2 hard. The impact absorber 17 defines a braking distance that is relatively long. It is at least 10% of the maximum deflection of the damper mass 4. The damper mass 4 is therefore not stopped abruptly when the stop buffer 14, 15 comes into contact with the stop 11, 12. The load on the supporting structure 2 can thus be kept to a minimum.

The stop buffers 14, 15 are attached to the damper mass 4 with their housing 16. The attachment is designed in such a way that the position of the stop buffers 14, 15 on the damper mass 4 can be varied and thus adjusted.

The position of the stop buffers 14, 15 on the damper mass 4 is selected in such a way that, in the stable center position of the damper mass 4 shown, a distance between the stop buffer 14 and the corresponding stop 11 is equal to a distance between the other stop buffer 15 and the corresponding stop 12. The movement possibilities of the damper mass 4 are the same in both movement directions on the rail arrangement 8.

FIG. 1 shows an ideal state that is often not achieved in reality.

FIG. 2 shows a somewhat exaggerated representation of the situation that arises when the supporting structure 2 is inclined or tilted in relation to the direction of gravity g. This type of situation occurs relatively frequently in wind turbine towers, particularly in offshore wind turbine towers.

In FIG. 2, the same reference symbols are used for the same elements as in FIG. 1. The drawing is only schematic in order to simplify the explanation. In real vibration damper arrangements, care is taken to ensure that the damper mass 4 does not come into contact with the enclosure 13 or the supporting structure 2 during its movement.

If the central axis 3 of the supporting structure 2 is inclined relative to the direction of gravity g, then the stable central position of the damper mass 4, i.e. the position in which the damper mass 4 can no longer move further downwards in the direction of gravity, is no longer in the middle of the rail arrangement 8, but offset to the side.

In order to nevertheless design a movement of the damper mass 4 in both movement directions on the rail arrangement 8 in equal manner, at least one stop buffer 14, 15, but usually both stop buffers 14, 15, are arranged offset relative to the damper mass 4. In other words, the position of the stop buffers 14, 15 on the damper mass 4 is being adjusted.

If the two stop buffers 14, 15 have a common housing 16, this can be accomplished simply by attaching the housing 16 to the damper mass 4 at a different position. This ensures that a distance between the stop buffer 14 and the stop 11 on one side in the direction of movement can be made just as large as a distance between the stop buffer 15 and the stop 12 in the opposite direction. If, as shown, the housing 16 is moved towards the stop 11, the distance between the stop buffer 14 and the stop 11 is reduced and the distance between the stop buffer 15 and the stop 12 is increased at the same time and to the same extent. Both distances can therefore be varied (changed) with a single adjustment.

A line connecting the two stop buffers 14, 15 runs approximately at the height of the center of gravity 5 in the direction of gravity. This virtual line runs in a region that extends on both sides of the center of gravity 5 of the damper mass 4 in the direction of gravity and has a maximum extension of 15% of the height of the damper mass 4 in the direction of gravity. The height of the damper mass 4 is the extension of the damper mass 4 in the direction of gravity g.

However, it is preferable if the stop buffers 14, 15 are located slightly below the center of gravity 5 of the damper mass 4 in the direction of gravity g. Since the movement of the damper mass 4 due to the oscillating movement on the curved rail arrangement 8 is not only linear, but also has a rotational component, it is advantageous to mount the stop buffers 14, 15 vertically offset to the center of gravity 5 in such a way that when the stop buffers 14, 15 collide with the respective stop 11, 12, a torque counteracting the rotational movement is produced. This keeps the forces on components of the vibration damper arrangement 1 and the supporting structure 2 caused by the impact of the damper mass 4 on the connecting elements 9, 10 small and prevents a large tilting moment on the damper mass 4.

By adjusting the position of the stop buffers 14, 15 on the damper mass 4, it is now possible to easily mount the vibration damper arrangement 1 in the supporting structure 2. After assembly, it is only thing to do is to position the damper mass 4 in its stable central position and fix it there if necessary. The position of the stop buffers 14, 15 on the damper mass 4 can then be adjusted such that the distances between the stop buffers 14, 15 and the respective stops 11, 12 are the same.

What is claimed is:

1. A vibration damper arrangement, especially for tall, slender structures, with a supporting structure, a damper mass having a center of mass, at least one wheel by means of which the damper mass is movable, on a concavely curved rail arrangement connected to the supporting structure, from a stable central position in two opposite movement directions, and a stop arrangement comprising, for each of the two opposite movement directions of the damper mass on the concavely curved rail arrangement, at least two stop buffers on the damper mass and at least two stops against which the least two stop buffers come to rest, characterized in that a distance between the at least two stop buffers and the at least two stops in the stable central position of the damper mass is variable for at least one of the movement directions, wherein the stop arrangement varies, such that varying the distance in the one of the movement directions, the distance in the opposite movement direction equally in an opposite manner.

2. The vibration damper arrangement according to claim 1, characterized in that the at least two stop buffers are arranged adjustably on the damper mass.

3. The vibration damper arrangement according to claim 2, characterized in that the at least two stop buffers are arranged on the damper mass so as to be jointly adjustable for each of the two opposite movement directions.

4. The vibration damper arrangement according to claim 1, characterized in that the at least two stops transmit impact forces from the stop buffer operatively associated each stop to the supporting structure.

5. The Vibration damper arrangement according to claim 4, characterized in that the at least two stops are rigidly attached to the supporting structure.

6. The vibration damper arrangement according to claim 1, characterized in that the at least two stop buffers have a common damping element.

7. Vibration damper arrangement according to claim 6, characterized in that the common damping element defines a braking distance which corresponds to at least 10% of a maximum deflection of the damper mass.

8. The vibration damper arrangement according to claim 1, characterized in that a line connecting the at least two stop buffers runs in a region which extends on both sides of the center of mass of the damper mass in a direction of gravity and has an extension in the direction of gravity of 15% of a height of the damper mass at a maximum.

9. The vibration damper arrangement according to claim 8, characterized in that the line runs in the direction of gravity below the center of mass.

10. A method for setting up a vibration damper arrangement, especially for tall, slender buildings, with a supporting structure, a damper mass which has a center of mass, at least one wheel by means of which the damper mass is movable, on a concavely curved rail arrangement connected to the supporting structure, from a stable central position in two opposite movement directions, and a stop arrangement comprising, for each of the two opposite movement directions of the damper mass on the concavely curved rail arrangement, at least two stop buffers on the damper mass and at least two stops against which the at least two stop buffers come to rest, characterized in that a distance between the at least two stop buffers and the at least two stops in the stable central position of the damper mass is varied for at least one of the movement directions, wherein, when varying the distance in the one of the movement directions, the distance in the opposite movement direction is varied equally in an opposite manner.

11. The method according to claim 10, characterized in that a position of the at least two stop buffers on the damper mass is varied.

12. The method according to claim 10, characterized in that the damper mass is arranged in the stable central position and the at least two stop buffers are arranged on the damper mass such that the distance between the at least two stop buffers and the stop operatively associated with each stop buffer is the same.

13. The method according to claim 10, characterized in that a common damping element is used for the at least two stop buffers.
